(19) United States
(12) Patent Application Publication
(10) Pub. No.: US 2026/0364768 A1
(43) Pub. Date: Nov. 19, 2026

(54) PEX CUTTER WITH INTEGRATED BLADE STORAGE

(71) Applicant: Clever Ltd. Co., Greenville, SC (US)

(72) Inventor: Austin Clark, Greenville, SC (US)

(73) Assignee: Clever Ltd. Co., Greenville, SC (US)

(21) Appl. No.: 19/680,779

(22) Filed: May 18, 2026

Related U.S. Application Data
(60) Provisional application No. 63/807,312, filed on May 16, 2025.

(51) Int. Cl. B25G 1/08; B26D 3/16

(52) U.S. Cl. CPC B25G 1/08; B26D 3/169

(57) ABSTRACT

A PEX cutter is provided, comprising: a receiving handle; a blade handle pivotally connected to the receiving handle at a handle pivot; a blade removably secured to the blade handle, the blade configured to engage with a pipe support on the receiving handle when the receiving handle and the blade handle are in a closed position; and a storage area disposed within the blade handle, the storage area configured to store at least one extra blade.

### RELATED APPLICATIONS

This application claims priority to United States Provisional Application No. 63/807,3312 filed 05/16/2025, which is hereby incorporated by reference in its entirety.

### BACKGROUND OF THE INVENTION

### 1 FIELD OF INVENTION

The present disclosure relates generally to plumbing tools, and more particularly to a PEX cutter having replaceable blades and integrated blade storage.

### 2 DESCRIPTION OF THE RELATED ART

In the field of plumbing and pipe cutting, PEX tubing has become widely used for water supply lines and other applications. Cutting PEX tubing requires specialized tools that can produce clean, square cuts to ensure proper fitting connections. Various PEX cutters have been developed, including scissor-style cutters that operate with a pivoting blade mechanism. While these tools have proven useful for cutting PEX tubing, the need for frequent blade replacement remains a common challenge faced by professionals in the field. This has been a problem due to the current configuration of cutters and has existed since at least the 1970s.

Currently, when a blade becomes dull or damaged during a plumbing job, operators may need to interrupt their work to locate replacement blades. This can require leaving the work area, finding the appropriate replacement blade from a tool bag or storage location, and returning to the task. In job site settings, this process can consume valuable time and disrupt workflow. In commercial or industrial environments where multiple workers may be operating simultaneously, the lack of readily available replacement blades can create bottlenecks as workers wait for access to sharp cutting tools. These interruptions can lead to decreased efficiency and increased project costs.

The plumbing industry has expressed interest in PEX cutters that offer improved blade management capabilities. Surveys of professional plumbers have indicated that a majority would find value in having spare blades readily available within the tool itself, as well as the ability to replace worn blades without complete blade replacement. However, existing PEX cutters on the market may not fully address these preferences, leaving opportunities for innovation in PEX cutter design to better meet the needs of plumbing professionals.

It is an object of the present cutter to provide integrated blade storage within the tool to reduce downtime during blade replacement operations.

It is a further object of the present cutter to provide a blade locking mechanism that securely retains the blade during cutting operations while allowing for quick and safe blade replacement when needed.

### BRIEF SUMMARY OF THE INVENTION

The above objectives are accomplished by providing a PEX cutter comprising a receiving handle, a blade handle pivotally connected to the receiving handle at a handle pivot, a blade removably secured to the blade handle, the blade configured to engage with a pipe support on the receiving handle when the receiving handle and the blade handle are in a closed position, and a storage area disposed within the blade handle, the storage area configured to store at least one extra blade.

The PEX cutter may include a storage area cover configured to provide access to the storage area. The storage area cover may be slidably attached to the blade handle. In another configuration, the storage area cover may be removably affixed to the blade handle. The PEX cutter may include a spring positioned between the receiving handle and the blade handle to bias the receiving handle and the blade handle in an open position. A handle lock may be configured to secure the receiving handle and the blade handle in the closed position. The PEX cutter may include a receiving handle grip disposed on the receiving handle, wherein the receiving handle grip is made from a material selected from the group consisting of rubber, plastic, and polymer.

In another configuration, a PEX cutter is provided comprising a receiving handle including a pipe support, a blade handle pivotally connected to the receiving handle, a blade removably secured to the blade handle, a storage area disposed within the blade handle, and an end cap positioned at one end of the blade handle. The end cap includes an end cap arm extending from an end cap head, the end cap head configured to engage with an end cap slot on the blade handle to provide a closure for the storage area.

The end cap may be configured to be manipulated to access the storage area within the blade handle. The storage area may be configured to store at least one extra blade. The end cap may be configured to allow insertion of replacement blades into the blade handle. The PEX cutter may include a spring positioned between the receiving handle and the blade handle to bias the receiving handle and the blade handle in an open position. The PEX cutter may include a blade lock mechanism configured to removably secure the blade to the blade handle. The blade lock mechanism may comprise a blade lock configured to engage with a blade top notch on the blade and a blade lock spring biasing the blade lock against the blade.

In another configuration, a PEX cutter is provided comprising a receiving handle including a pipe support, a blade handle pivotally connected to the receiving handle, a blade removably secured to the blade handle, and a spare blade carrier pivotally mounted to the blade handle. The spare blade carrier is configured to store at least one spare blade and is movable between an open position and a closed position.

The PEX cutter may include a spare blade carrier detent configured to secure the spare blade carrier in the closed position. The spare blade carrier may include a spare blade carrier grip configured to assist a user in positioning the spare blade carrier between the open position and the closed position. The spare blade carrier may pivot about a spare blade carrier pivot, the spare blade carrier pivot including a stud that serves as an axis of rotation for the spare blade carrier. The blade handle may comprise two lateral parts secured together by handle fasteners. The handle fasteners may allow the spare blade carrier to pivot freely between the open position and the closed position.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIGS. 1 and 2 are views of aspects of a PEX cutter;

FIGS. 3 and 4 are views of aspects of the PEX cutter;

FIGS. 5 and 6 are views of aspects of the PEX cutter;

FIG. 7 is a cutaway view of aspects of the PEX cutter;

FIGS. 8 and 9 are views of aspects of the PEX cutter;

FIG. 10 is a view of aspects of the PEX cutter; and,

FIGS. 11 and 12 are views of aspects of the PEX cutter.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments. The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DETAILED DESCRIPTION OF THE INVENTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure. Modifiers such as “first” and “second” may be used to differentiate elements, but the modifiers do not necessarily indicate any particular order.

With reference to the drawings, the invention will now be described in more detail.

A PEX cutter is a plumbing tool designed for cutting PEX tubing. PEX tubing, or cross-linked polyethylene tubing, is a flexible plastic tubing commonly used in water supply lines and other plumbing applications. The PEX cutter provides clean, square cuts to PEX tubing to ensure proper fitting connections during plumbing installations.

The PEX cutter includes a receiving handle and a blade handle. The receiving handle and the blade handle are pivotally connected at a handle pivot, allowing for scissor-like operation of the PEX cutter. The receiving handle includes a pipe support configured to receive and support a pipe during cutting operations. The blade handle carries a blade that engages with the pipe support when the handles are moved toward a closed position.

In one configuration, the PEX cutter incorporates integrated blade storage capabilities. The blade handle includes a storage area configured to receive and store one or more extra blades. A storage door or storage area cover provides access to the storage area, allowing users to retrieve replacement blades during cutting operations without leaving the work area. This integrated blade storage configuration can reduce downtime during blade replacement operations. Reducing downtime during blade replacement operations can improve overall efficiency and productivity for plumbing professionals. When operators must stop work to locate replacement blades, the time spent searching for and retrieving blades represents non-productive labor that adds to project costs. In commercial settings where labor is billed hourly, even brief interruptions can accumulate over the course of a project. Additionally, workflow disruptions can affect the quality of work as operators may be tempted to continue using dull blades rather than interrupt their tasks, potentially resulting in suboptimal cuts that require rework. Even a momentary interruption can result in lost focus, mistakes, and incomplete jobs.

In one embodiment, a spring is positioned between the receiving handle and the blade handle to bias the handles in an open position. The spring can facilitate easier operation and reduce user fatigue during repeated cutting tasks. A handle lock can be included to secure the handles in the closed position during storage or transport of the PEX cutter.

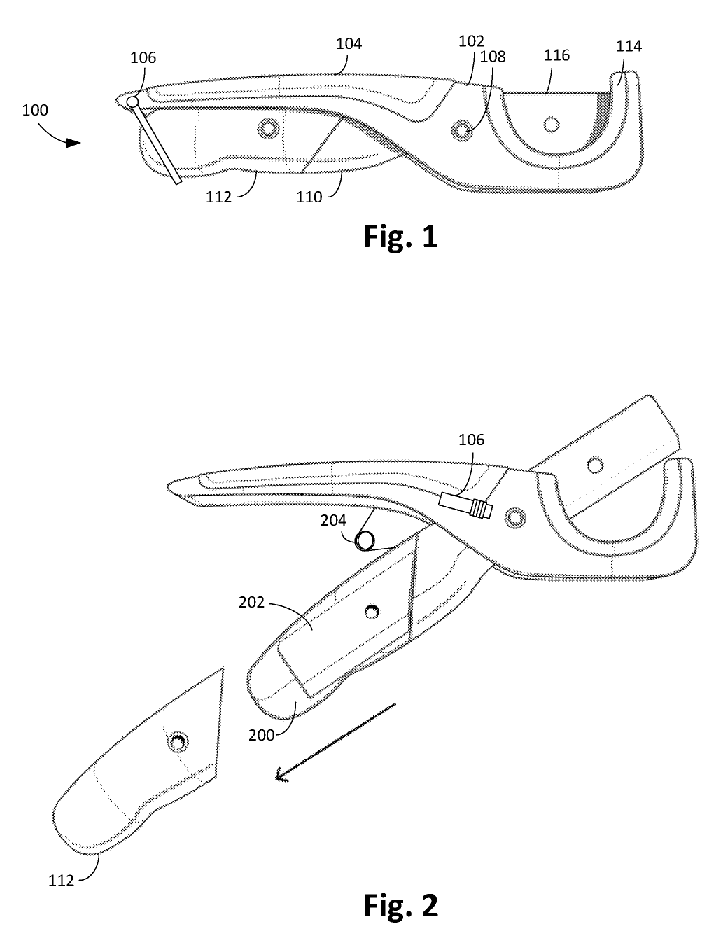

Referring to FIGS. 1 and 2, a PEX cutter 100 includes a receiving handle 102 and a blade handle 110. The receiving handle 102 and the blade handle 110 are pivotally connected at a handle pivot 108, allowing for scissor-like operation of the PEX cutter 100. A receiving handle grip 104 is disposed on the receiving handle 102. In one configuration, the receiving handle grip 104 is made from a rubberized material to improve comfort, ergonomics, and grip for a user. In another configuration, the receiving handle grip 104 is made from plastic to improve comfort, ergonomics, and grip for a user. In another configuration, the receiving handle grip 104 is made from polymer to improve comfort, ergonomics, and grip for a user.

The PEX cutter 100 includes a blade 116 secured to the blade handle 110. The receiving handle 102 includes a pipe support 114 configured to receive and support a pipe during cutting operations. The blade 116 is received into the pipe support 114 when the handles are in a closed position. A handle lock 106 is included to secure the handles in the closed position during storage or transport.

The blade handle 110 includes a storage area 200 configured to receive and store an extra blade 202. A storage door 112 provides access to the storage area 200. In one configuration, the storage door 112 is slidably attached to the blade handle 110 for accessing the storage area 200. In another configuration, the storage door 112 is removably affixed to the blade handle 110, allowing for easy replacement of the extra blade 202. In another configuration, the storage door 112 is pivotally attached to the blade handle 110, allowing the storage door 112 to swing open to provide access to the storage area 200.

A spring 204 is positioned between the receiving handle 102 and the blade handle 110 to bias the handles in an open position. The spring 204 facilitates easier operation and reduces user fatigue during repeated cutting tasks.

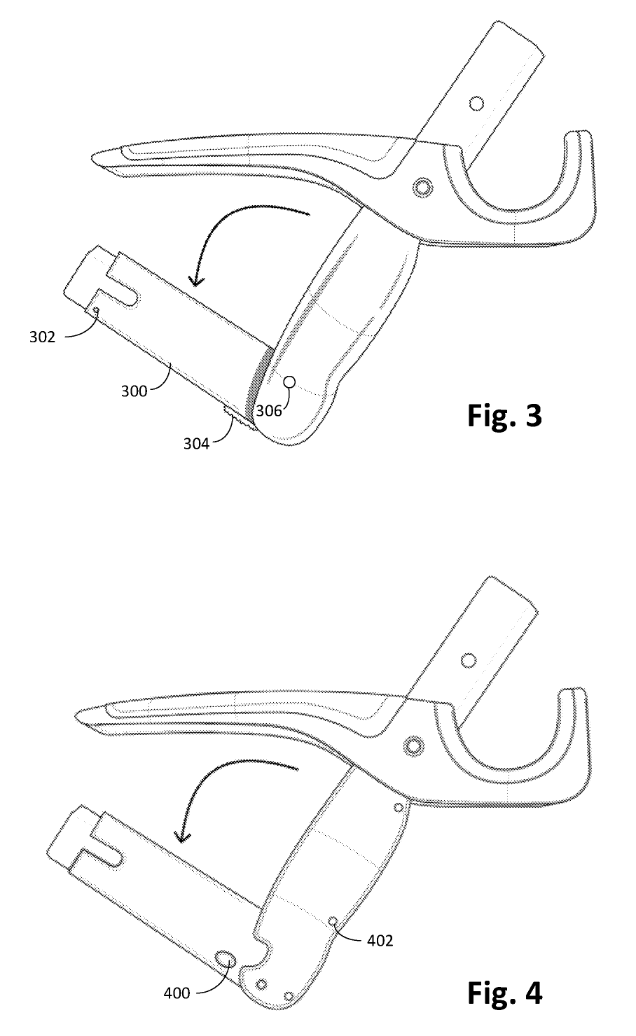

Referring to FIGS. 3 and 4, the PEX cutter includes a spare blade carrier 300 that is pivotally mounted to the blade handle 110. The spare blade carrier 300 is configured to move between an open position and a closed position relative to the blade handle 110. The spare blade carrier 300 provides storage for one or more spare blades within the blade handle 110.

The spare blade carrier 300 includes a spare blade carrier detent 302 that secures the spare blade carrier 300 in the closed position within the blade handle 110. The spare blade carrier detent 302 engages with a corresponding feature on the blade handle 110 to maintain the spare blade carrier 300 in the closed position during normal cutter operation.

The spare blade carrier 300 includes a spare blade carrier grip 304 to assist a user in positioning the spare blade carrier 300 between the open position and the closed position. The spare blade carrier grip 304 provides a gripping surface that allows a user to manipulate the spare blade carrier 300 for accessing spare blades stored within the blade handle 110.

The spare blade carrier 300 pivots about a spare blade carrier pivot 306. The spare blade carrier pivot 306 includes a stud 400 that serves as the axis of rotation for the spare blade carrier 300. The stud 400 enables precise positioning of the spare blade carrier 300 as the spare blade carrier 300 moves between the open position and the closed position.

In one configuration, the blade handle 110 includes two lateral parts that are secured together using handle fasteners 402. The handle fasteners 402 provide a secure connection between the two lateral parts of the blade handle 110 while allowing the spare blade carrier 300 to pivot freely between the open position and the closed position. In one embodiment, the handle fasteners 402 include fastening rivets. In another configuration, the handle fasteners 402 include screws or similar fasteners in place of fastening rivets.

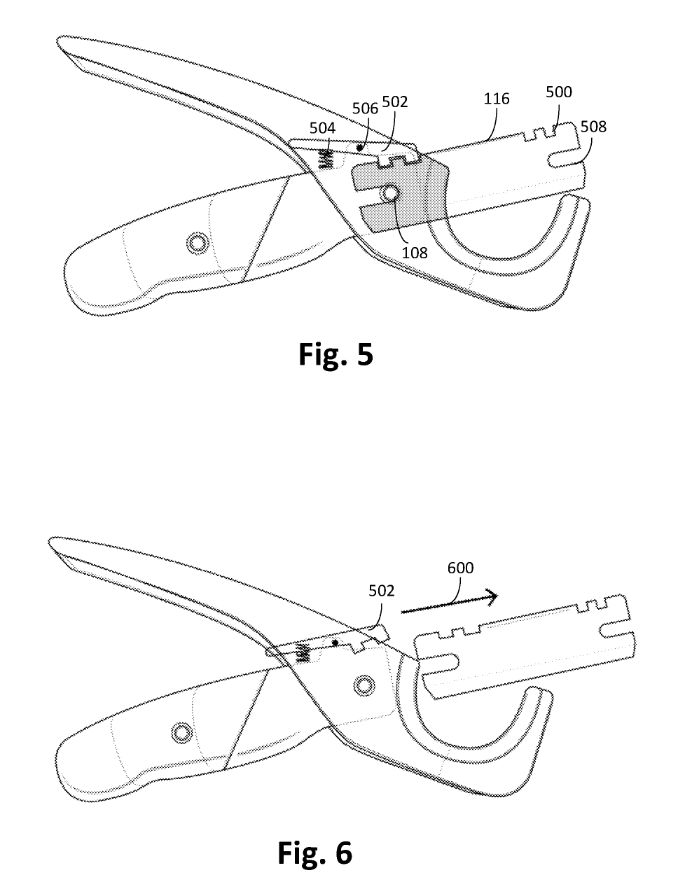

Referring to FIGS. 5 and 6, the PEX cutter includes a blade locking mechanism configured to secure the blade 116 to the blade handle 110 during cutting operations while allowing for blade replacement when needed.

The blade 116 includes a blade top notch 500 along a top edge of the blade 116. The blade top notch 500 is configured to engage with a blade lock 502. The blade lock 502 is a component that secures the blade 116 within the blade handle 110 during cutting operations. The blade lock 502 pivots about a blade lock pivot 506, which serves as the axis of rotation for the blade lock 502.

A blade lock spring 504 is associated with the blade lock 502. The blade lock spring 504 biases the blade lock 502 against the blade 116, maintaining engagement between the blade lock 502 and the blade top notch 500. This spring-loaded configuration helps ensure that the blade 116 remains securely in place during use.

The blade lock 502 includes blade lock pins 510 configured to engage with the blade top notch 500. In one configuration, the blade lock pins 510 include a single pin configured to engage with the blade top notch 500. In another configuration, the blade lock pins 510 include multiple pins configured to engage with the blade top notch 500. The blade lock pins 510 can have various shapes to enhance the security of the blade-locking mechanism. In one embodiment, the blade lock pins 510 have squared shapes. In another embodiment, the blade lock pins 510 have angled shapes. In another embodiment, the blade lock pins 510 have tooth-shaped configurations.

The blade 116 includes a blade lateral notch 508 on a side of the blade 116. The blade lateral notch 508 is designed to receive a pin, such as the handle pivot 108. The engagement between the blade lateral notch 508 and the handle pivot 108 provides an additional securing point that further stabilizes the blade 116 within the blade handle 110.

When the blade lock 502 is released from engagement with the blade top notch 500, the blade 116 can be removed from the blade handle 110. A blade replacement direction 600 indicates the direction in which the blade 116 is extracted from the blade handle 110 when the blade lock 502 is disengaged. This removal direction allows for smooth and safe blade extraction during blade changes.

In one configuration, the blade lock mechanism may be configured as a quick release mechanism that allows for one-handed blade removal. Some prior blade retention designs may use pins or screws that require tools or two-handed operation to release the blade, which can cause more interruption during blade changes. In contrast, the quick release mechanism allows a user to actuate the blade lock 502 with a single hand, such as by applying thumb or finger pressure to the blade lock 502, to disengage the blade lock 502 from the blade top notch 500. This allows the blade 116 to be removed from the blade handle 110 without the use of tools. The quick release configuration may reduce blade replacement time and allow the user to maintain grip on the PEX cutter 100 with the same hand while performing the blade change operation.

In one configuration, the blade 116 may include a double-sided blade configuration. The blade 116 may include a first blade edge on a first side of the blade 116 and a second blade edge on a second side of the blade 116 opposite the first side. When the first blade edge becomes dull or damaged, the blade 116 can be removed from the blade handle 110 and rotated 180 degrees about a longitudinal axis of the blade 116. The blade 116 can then be reinserted into the blade handle 110 so that the second blade edge is positioned in the cutting position. This configuration allows a user to obtain twice the cutting life from a single blade 116 before replacement is needed. The blade top notch 500 and the blade lateral notch 508 may be configured to allow the blade 116 to be secured in either orientation within the blade handle 110.

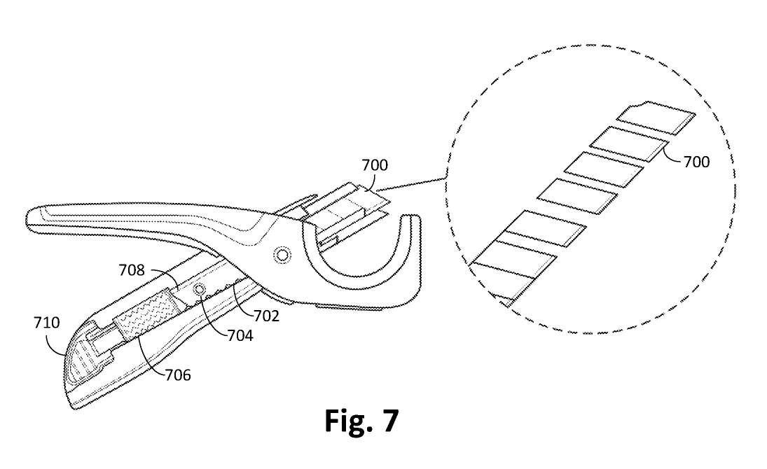

Referring to FIG. 7, the PEX cutter includes a segmented blade 702 housed within the blade handle. The segmented blade 702 includes a plurality of blade portions 700 arranged in a linear configuration. The blade portions 700 are designed to be detachable from the segmented blade 702 at predetermined score lines. The blade portions 700 can be separated from the segmented blade 702 when the blade portions 700 become dull or damaged, allowing for removal of dulled or damaged segments while retaining usable portions of the segmented blade 702.

A segmented blade track 708 is disposed within the blade handle to house the segmented blade 702. The segmented blade track 708 serves as a guided pathway for the segmented blade 702, ensuring smooth movement within the blade handle during blade advancement and retraction.

The PEX cutter includes a segmented blade advance 706 mechanism positioned along the blade handle. The segmented blade advance 706 is connected to the segmented blade 702 through a segmented blade pin 704. The segmented blade pin 704 allows for controlled advancement of new blade portions 700 as needed. This configuration facilitates efficient blade replacement and reduces downtime during cutting operations by allowing users to advance fresh blade portions 700 as older blade portions 700 become worn.

An end cap 710 is positioned at one end of the blade handle. The end cap 710 is configured to allow for insertion of replacement segmented blades 702 into the PEX cutter. The end cap 710 facilitates reloading of the segmented blade system, extending the overall lifespan of the cutting tool.

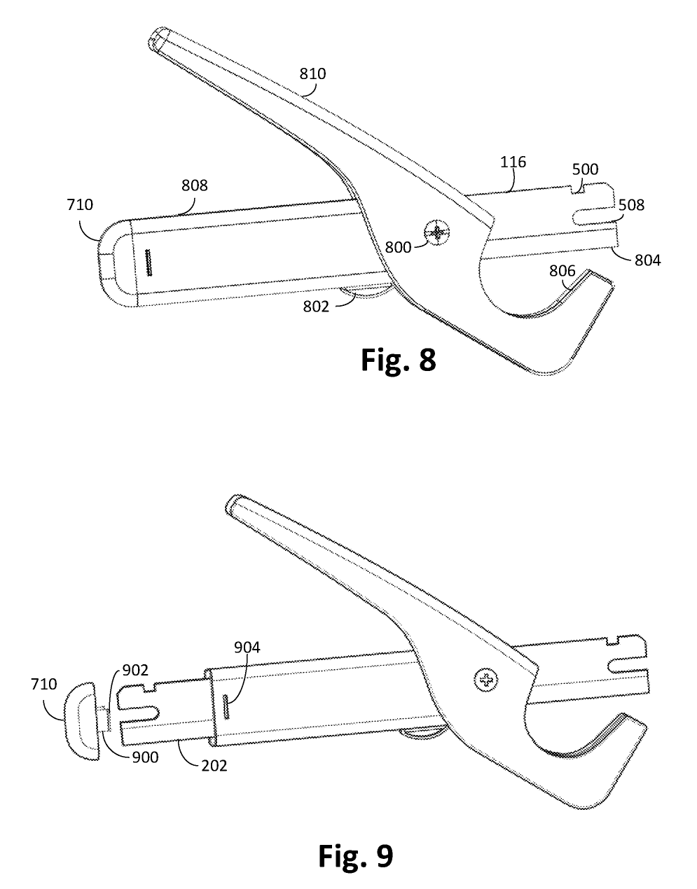

Referring to FIGS. 8 and 9, the PEX cutter includes a blade assembly with a fixed handle 808 and a movable handle 810. The fixed handle 808 and the movable handle 810 are connected by a pivot 800, allowing for scissor-like operation of the cutting mechanism. A bias spring 802 is positioned between the fixed handle 808 and the movable handle 810 to bias the handles in an open position. The bias spring 802 can facilitate easier operation and reduce user fatigue during repeated cutting tasks.

The blade 116 is secured to the blade handle assembly. The blade 116 includes a blade top notch 500 along an upper edge of the blade 116 and a blade lateral notch 508 on a side of the blade 116. The blade top notch 500 and the blade lateral notch 508 are configured to engage with locking mechanisms to secure the blade 116 within the blade handle during cutting operations.

The blade 116 includes a blade edge 804. A blade edge receiving slot 806 is disposed on the receiving portion of the PEX cutter. In one configuration, the blade edge receiving slot 806 is disposed on the pipe support. The blade edge 804 is received into the blade edge receiving slot 806 when the handles are moved toward a closed position. The blade edge 804 is located at a distal end of the blade 116, and the blade edge receiving slot 806 receives this distal end when in the closed position. The blade edge receiving slot 806 may cover the blade edge 804 and the distal end of the blade 116 when in the closed position to improve safety and prevent exposed sharp edges. The blade edge receiving slot 806 supports the pipe during cutting operations and receives the blade edge 804 as the blade 116 passes through the pipe material.

In one configuration, the blade 116 includes a pointed tip configuration. The pointed tip configuration can facilitate initial penetration into the pipe material during cutting operations. In another configuration, the PEX cutter is formatted with a square blade style. The square blade style can communicate a professional product appearance.

An end cap 710 is positioned at one end of the blade handle. The end cap 710 includes an end cap arm 900 that extends from an end cap head 902. The end cap head 902 is configured to engage with an end cap slot 904 on the blade handle. The engagement between the end cap head 902 and the end cap slot 904 provides a secure closure for the storage area within the blade handle.

The end cap 710 can be manipulated to access the storage area within the blade handle. In one configuration, the end cap 710 may be removable from the blade handle, allowing the end cap 710 to be fully detached for accessing the storage area. When the end cap head 902 is disengaged from the end cap slot 904, the end cap 710 can be moved to expose the storage area. This configuration facilitates insertion and removal of replacement blades while maintaining secure storage during normal cutting operations.

An extra blade 202 is stored within the handle assembly. The extra blade 202 is visible within the storage area of the blade handle. The storage area provides a compartment where replacement blades are stored within the PEX cutter for convenient access during blade changes. The end cap 710 mechanism allows users to retrieve the extra blade 202 without leaving the work area, reducing downtime during blade replacement operations.

In one embodiment, the extra blade 202 has a configuration that matches the blade 116 secured to the blade handle assembly. In another embodiment, the extra blade 202 has a different blade configuration than the blade 116. The storage area can accommodate blades of various configurations, including blades with pointed tip configurations and blades with square blade styles.

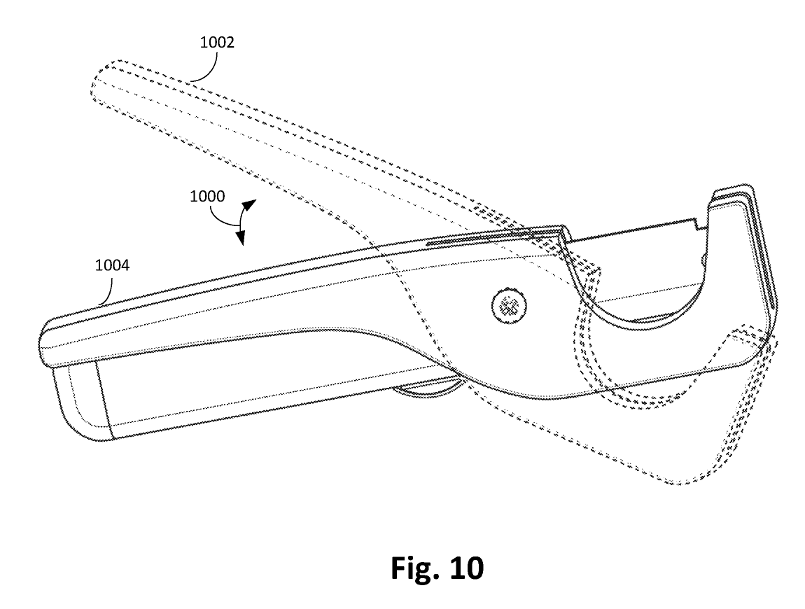

Referring to FIG. 10, the PEX cutter includes a blade handle that pivots relative to the receiving handle in a scissor-like operation. A travel arc 1000 indicates the path of movement of the blade handle as the blade handle pivots between positions. The travel arc 1000 shows the range of motion of the blade handle during cutting operations.

The blade handle is configured to move between an open position 1002 and a close position 1004. The open position 1002 corresponds to the blade handle pivoted away from the receiving handle, allowing a pipe to be positioned within the cutting area of the PEX cutter. The close position 1004 corresponds to the blade handle moved toward the receiving handle, engaging the blade with a pipe positioned in the pipe support area.

In operation, a user positions a pipe within the pipe support region between the blade and blade receiving slot when the blade handle is in the open position 1002. The user then moves the blade handle along the travel arc 1000 toward the close position 1004. As the blade handle moves toward the close position 1004, the blade engages with the pipe material and cuts through the pipe. The scissor-like operation of the handles provides mechanical advantage during cutting, allowing the user to apply cutting force to the pipe with reduced effort.

The pivoting motion indicated by the travel arc 1000 demonstrates the range of movement available to the blade handle during cutting operations. The travel arc 1000 extends from the open position 1002 to the close position 1004, defining the operational range of the blade handle. The receiving handle includes a curved pipe support region configured to receive and support a pipe during cutting operations, and the blade passes through the pipe support region as the blade handle moves toward the close position 1004.

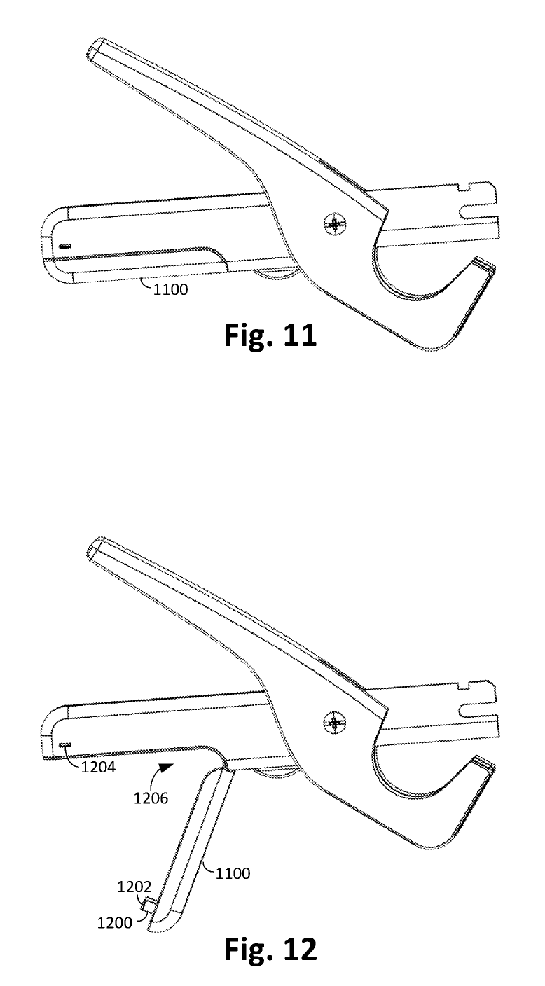

Referring to FIGS. 11 and 12, the PEX cutter includes a storage area cover 1100 positioned on the blade handle. The storage area cover 1100 is configured to cover a storage area 1206 within the blade handle. The storage area 1206 provides a compartment where replacement blades are stored within the PEX cutter for convenient access during blade changes.

The PEX cutter includes a latch mechanism configured to secure the storage area cover 1100 in a closed position. The latch mechanism includes a latch arm 1200 that extends from the storage area cover 1100. The latch arm 1200 terminates in a latch head 1202. The latch head 1202 is configured to engage with a latch slot 1204 on the blade handle.

When the latch head 1202 is engaged with the latch slot 1204, the storage area cover 1100 is secured in the closed position. The engagement between the latch head 1202 and the latch slot 1204 maintains secure storage of spare blades within the storage area 1206 during normal cutting operations.

In one configuration, the latch head 1202 can be disengaged from the latch slot 1204 to allow the storage area cover 1100 to be moved to an open position. When the storage area cover 1100 is in the open position, the storage area 1206 is exposed, allowing a user to access replacement blades stored within the blade handle. The latch mechanism facilitates insertion and removal of replacement blades while permitting secure closure of the storage area 1206 when blade replacement is not being performed.

A spring or bias spring positioned between the receiving handle and the blade handle biases the handles toward an open position. The spring returns the handles to the open position after a cutting operation is completed, allowing a user to position another pipe within the cutting area without manually separating the handles. The spring can reduce user fatigue during repeated cutting tasks by providing automatic handle separation.

The storage area and spare blade carrier provide accessible replacement blades during cutting operations. The blade handle includes a storage area configured to receive and store one or more extra blades. A storage door or storage area cover provides access to the storage area, and a user can retrieve replacement blades from the storage area without leaving the work area. In one configuration, the spare blade carrier is pivotally mounted to the blade handle and moves between an open position and a closed position. A spare blade carrier detent secures the spare blade carrier in the closed position within the blade handle during normal cutter operation. A spare blade carrier grip assists a user in positioning the spare blade carrier between the open position and the closed position. The spare blade carrier pivots about a spare blade carrier pivot, and a stud serves as the axis of rotation for the spare blade carrier.

In one configuration, a latch mechanism secures a storage area cover in a closed position. The latch mechanism includes a latch arm that extends from the storage area cover and terminates in a latch head. The latch head engages with a latch slot on the blade handle to maintain secure storage of spare blades within a storage area during normal cutting operations. When the latch head is disengaged from the latch slot, the storage area cover can be moved to an open position to expose the storage area.

In one embodiment, an end cap is positioned at one end of the blade handle. The end cap includes an end cap arm that extends from an end cap head, and the end cap head engages with an end cap slot on the blade handle to provide a secure closure for the storage area. The end cap can be manipulated to access the storage area within the blade handle for insertion and removal of replacement blades. In one configuration, the end cap may be removable from the blade handle to provide access to the storage area.

In one embodiment, an end cap positioned at one end of the blade handle allows for insertion of replacement segmented blades into the PEX cutter when all blade portions have been used.

One or more different inventions may be described in the present application. Further, for one or more of the invention(s) described herein, numerous embodiments may be described in this patent application, and are presented for illustrative purposes only. The embodiments described are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

It is understood that the above descriptions and illustrations are intended to be illustrative and not restrictive. It is to be understood that changes and variations may be made without departing from the spirit or scope of the following claims. Other embodiments as well as many applications besides the examples provided will be

apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A PEX cutter, comprising:
a receiving handle;
a blade handle pivotally connected to the receiving handle at a handle pivot;
a blade removably secured to the blade handle, the blade configured to engage with a pipe support on the receiving handle when the receiving handle and the blade handle are in a closed position;
a blade edge receiving slot disposed on the receiving handle, the blade edge receiving slot configured to enclose a blade edge of the blade when in the closed position;
a storage area disposed within the blade handle, the storage area configured to store at least one extra blade; and
a storage area cover configured to provide access to the storage area.

2. The PEX cutter of claim 1, wherein the blade edge receiving slot receives a distal end of the blade when in the closed position.

3. The PEX cutter of claim 1, including a storage area cover that is pivotally attached to the blade handle.

4. The PEX cutter of claim 1, including a storage area cover that is removably affixed to the blade handle.

5. The PEX cutter of claim 1, further comprising a spring positioned between the receiving handle and the blade handle to bias the receiving handle and the blade handle in an open position.

6. The PEX cutter of claim 1, further comprising a handle lock configured to secure the receiving handle and the blade handle in the closed position.

7. The PEX cutter of claim 1, further comprising a receiving handle grip disposed on the receiving handle, wherein the receiving handle grip is made from a material selected from a group consisting of rubber, plastic, and polymer.

8. A PEX cutter, comprising:
a receiving handle including a pipe support;
a blade handle pivotally connected to the receiving handle;
a blade removably secured to the blade handle;
a blade edge receiving slot disposed on the pipe support configured to receive a blade edge and a distal end of the blade when in a closed position;
a storage area disposed within the blade handle; and
an end cap positioned at one end of the blade handle, the end cap including an end cap arm extending from an end cap head, the end cap head configured to engage with an end cap slot on the blade handle to provide a closure for the storage area.

9. The PEX cutter of claim 8, wherein the end cap is removable from the blade handle.

10. The PEX cutter of claim 8, wherein the storage area is configured to store an extra blade.

11. The PEX cutter of claim 8, wherein the end cap is configured to allow insertion of a replacement blade into the blade handle.

12. The PEX cutter of claim 8, further comprising a spring positioned between the receiving handle and the blade handle to bias the receiving handle and the blade handle in an open position.

13. The PEX cutter of claim 8, further comprising a blade lock mechanism configured to removably secure the blade to the blade handle.

14. The PEX cutter of claim 13, wherein the blade lock mechanism comprises:
a blade lock configured to engage with a blade top notch on the blade; and
a blade lock spring biasing the blade lock against the blade.

15. A PEX cutter, comprising:
a receiving handle including a pipe support;
a blade handle pivotally connected to the receiving handle wherein the blade includes a first blade edge on a first side of the blade and a second blade edge on a second side of the blade opposite the first side, the blade configured to be removed from the blade handle, rotated about a longitudinal axis of the blade, and reinserted into the blade handle so that the second blade edge is positioned in a cutting position;
a blade lock mechanism configured as a quick release mechanism, the quick release mechanism configured to allow one-handed blade removal by actuation of a blade lock to disengage the blade lock from a blade top notch on the blade without the use of tools; and
a spare blade carrier carried by the blade handle, the spare blade carrier configured to store at least one spare blade and having an open position and a closed position.

16. The PEX cutter of claim 15, further comprising a spare blade carrier detent configured to secure the spare blade carrier in the closed position.

17. The PEX cutter of claim 15, wherein the spare blade carrier includes a spare blade carrier grip configured to assist a user in positioning the spare blade carrier between the open position and the closed position.

18. The PEX cutter of claim 15, wherein the spare blade carrier pivots about a spare blade carrier pivot, the spare blade carrier pivot including a stud that serves as an axis of rotation for the spare blade carrier.

19. The PEX cutter of claim 15, wherein the blade handle comprises two lateral parts secured together by handle fasteners.

20. The PEX cutter of claim 19, wherein the handle fasteners allow the spare blade carrier to pivot freely between the open position and the closed position.
